(19) United States
(12) Patent Application Publication
(10) Pub. No.: US 2010/0068944 A1
(43) Pub. Date: Mar. 18, 2010

(54) ELECTRICAL CONNECTOR AND CIRCUIT BOARD INTERCONNECT

(75) Inventor: Richard J. SCHERER, Austin, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 12/212,820

(22) Filed: Sep. 18, 2008

(51) Int. Cl. H01R 24/04

(52) U.S. Cl. 439/668

(57) ABSTRACT

An electrical connector assembly includes a printed circuit board, a header coupled to the printed circuit board, a carrier configured to mate with the header, and a plurality of electrical cable assemblies retained by the carrier. The printed circuit board has a printed circuit board ground contact. The header includes a plurality of contact pins. Each electrical cable assembly includes an electrical cable termination and an electrical cable coupled to the electrical cable termination. The header and electrical cable terminations are configured such that each of the electrical cable terminations makes electrical contact with at least one of the contact pins and printed circuit board ground contact when the header and carrier are in a mated configuration. The carrier includes a retention clip having a plurality of separating elements configured to separate at least a portion of the electrical cables from each other.

### TECHNICAL FIELD

The present invention relates to interconnections made between a printed circuit board and a high speed electrical connector. More particularly, it relates to a printed circuit board-connector combination for establishing contact between a printed circuit board and electrical cables.

### BACKGROUND

The interconnection of integrated circuits to other circuit boards, cables, or other electronic devices is well known in the art. Such interconnections typically have not been difficult to form, especially when the circuit switching speeds (also referred to as edge rates or signal rise times) have been slow when compared to the length of time required for a signal to propagate through a conductor in the interconnect or on the printed circuit board. However, as circuit switching speeds continue to increase with modem integrated circuits and related computer technology, the design and fabrication of satisfactory interconnects has grown more difficult.

Specifically, there is a growing need to design and fabricate printed circuit boards and their accompanying interconnects with closely controlled electrical characteristics to achieve satisfactory control over the integrity of the signal. In addition, there is a need to design the interconnects such that electrical cables can be properly connected without jeopardizing the integrity of the interconnect system.

Unfortunately, currently available high speed interconnect solutions are typically complex, requiring extremely accurate component designs which are very sensitive to even small manufacturing variations and which, as a result, are expensive and difficult to manufacture. What is needed is a printed circuit board interconnect system which provides the necessary impedance control for high speed integrated circuits and facilitates proper electrical cable connections, while still being inexpensive and easy to manufacture.

### SUMMARY

In one aspect, the present invention provides an electrical connector assembly including a printed circuit board, a header coupled to the printed circuit board, a carrier configured to mate with the header, and a plurality of electrical cable assemblies retained by the carrier. The printed circuit board has a printed circuit board ground contact. The header includes a plurality of contact pins. Each electrical cable assembly includes an electrical cable termination and an electrical cable coupled to the electrical cable termination. The header and electrical cable terminations are configured such that each of the electrical cable terminations makes electrical contact with at least one of the contact pins and printed circuit board ground contact when the header and carrier are in a mated configuration. The carrier includes a retention clip having a plurality of separating elements configured to separate at least a portion of the electrical cables from each other.

In another aspect, the present invention provides an electrical connector including a carrier and a plurality of electrical cable assemblies retained by the carrier. Each electrical cable assembly includes an electrical cable termination and an electrical cable coupled to the electrical cable termination. The carrier includes a retention clip having a plurality of separating elements configured to separate at least a portion of the electrical cables from each other.

In another aspect, the present invention provides a method including providing an electrical connector, positioning a retention clip, and assembling the retention clip to the electrical connector. The electrical connector includes a carrier and a plurality of electrical cable assemblies retained by the carrier. Each electrical cable assembly includes an electrical cable termination and an electrical cable coupled to the electrical cable termination. The retention clip has a plurality of separating elements. Each separating element is positioned in between at least a portion of two adjacent electrical cables.

The above summary of the present invention is not intended to describe each disclosed embodiment or every implementation of the present invention. The Figures and detailed description that follow below more particularly exemplify illustrative embodiments.

### BRIEF DESCRIPTION OF THE DRAWINGS

FIG. 1 is a partially exploded top perspective view of an exemplary embodiment of an electrical connector assembly according to an aspect of the present invention.

FIG. 2 is a top perspective view of the electrical connector assembly of FIG. 1.

FIGS. 3A-C are perspective views of a retention clip of the electrical connector assembly of FIG. 1.

FIG. 4 is a bottom perspective view of a portion of the electrical connector assembly of FIG. 1.

FIG. 5 is a back side view of a portion of the electrical connector assembly of FIG. 1.

### DETAILED DESCRIPTION

In the following detailed description of the preferred embodiments, reference is made to the accompanying drawings that form a part hereof. The accompanying drawings show, by way of illustration, specific embodiments in which the invention may be practiced. It is to be understood that other embodiments may be utilized, and structural or logical changes may be made without departing from the scope of the present invention. The following detailed description, therefore, is not to be taken in a limiting sense, and the scope of the invention is defined by the appended claims.

For purpose of clarity, aspects of the invention are described and illustrated herein as used with twinaxial cables and twinaxial cable terminations. However, such illustration is exemplary only, and it is understood and intended that other types of electrical cables and their associated electrical cable terminations can be used, including but not limited to coaxial cables and other cable configurations with signal and ground elements.

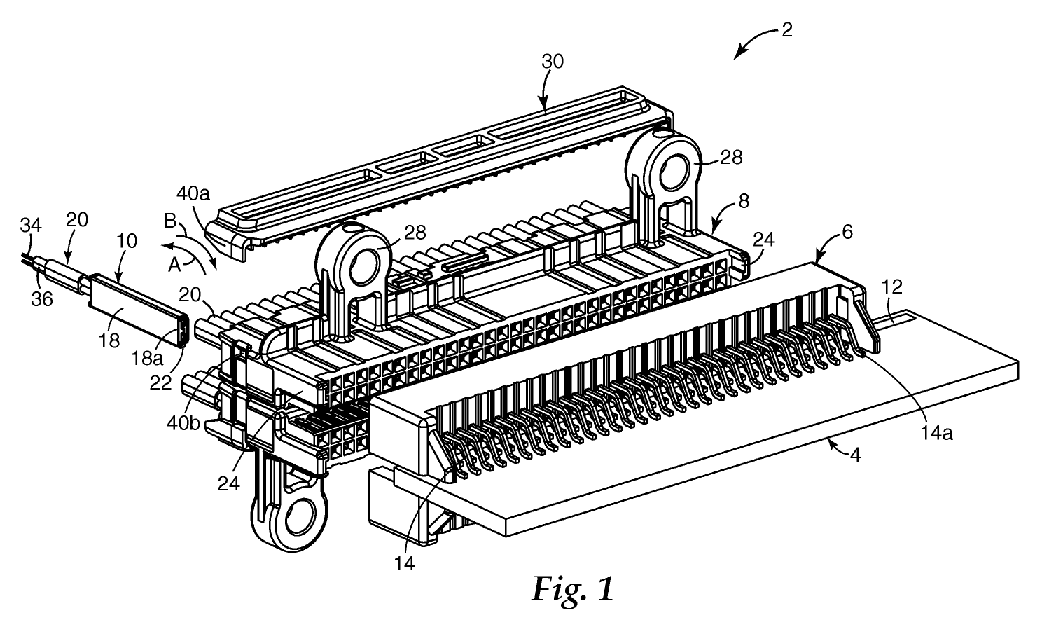

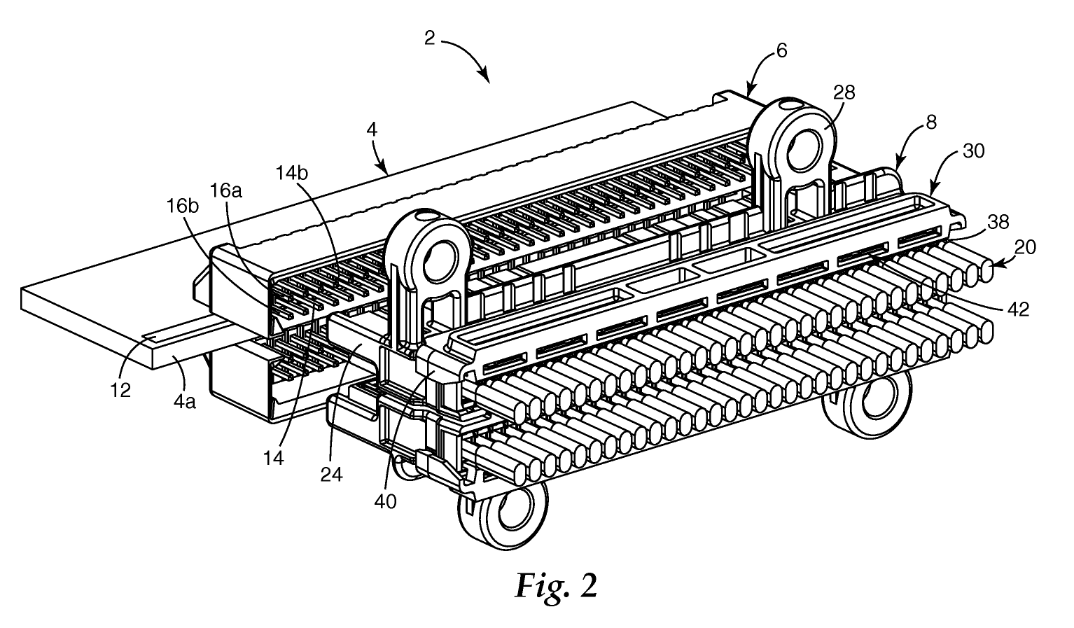

FIGS. 1 and 2 illustrate an exemplary embodiment of an electrical connector assembly according to an aspect of the present invention. Electrical connector assembly 2 includes a printed circuit board 4 having a printed circuit board ground contact 12. Printed circuit board ground contact 12 includes an electrically conductive strip positioned adjacent edge 4a of printed circuit board 4. In other embodiments, printed circuit board ground contact 12 may include one or more of a plurality of ground pins, an electrically conductive strip, and a plurality of ground pads. Electrical connector assembly 2 further includes a header 6 coupled to printed circuit board 4. Header 6 includes a plurality of contact pins 14 extending from a first pin end 14a attached to printed circuit board 4 to a second pin end 14b. Although header 6 is shown and described herein as a surface mount pin header, header 6 may also be a through-hole pin header or any other suitable type of header known in the art. Headers are commonly available from a variety of sources, including, for example, 3M Company, St. Paul, Minn. The commonly available headers 6 include two rows 16a, 16b of contact pins 14. Typically, one row of pins is connected to a ground plane (not shown) of printed circuit board 4, while the second row of pins is connected to signal traces (not shown) on printed circuit board 4. Most commonly, first row 16a (the row that is farthest from printed circuit board 4) is connected to a ground plane, while second row 16b (the row that is closest to printed circuit board 4) is connected to the signal traces of printed circuit board 4. Various combinations of contact pins 14 in rows 16a and 16b may be electrically connected to printed circuit board 4 in any number of ways, and may facilitate signal, power, or ground connections.

In one embodiment of the present invention, the first row 16a of contact pins 14 is secured to the printed circuit board 4 only to lend additional mechanical stability to header 6. That is, contact pins 14 in row 16a are not electrically connected to any elements on printed circuit board 4 and could be eliminated. Alternately, contact pins 14 of row 16a may remain in electrical contact with the ground plane of printed circuit board 4. It should be noted that first row 16a is the row with the longest unshielded path through the interconnection, and for that reason contact pins 14 of second row 16b are preferably used for electrical connection to the signal traces on printed circuit board 4. It will also be recognized that a header having only a single row of pins could be used, with the header being stabilized on printed circuit board 4 by means other than a second row of contact pins 14 as is illustrated in the Figures.

Contact pins 14 in second row 16b electrically connect to printed circuit board 4 via a plurality of signal contact pads (not shown). The first end 14a of each contact pin 14 in row 16b is connected to one of the signal contact pads. As illustrated in FIGS. 1 and 2, printed circuit board 4 may include a header 6 on both sides of printed circuit board 4, with similarly positioned signal pads and printed circuit board ground contact 12.

As seen in FIGS. 1 and 2, electrical connector assembly 2 also includes a carrier 8 configured to mate with header 6, and a plurality of electrical cable assemblies 10 retained by carrier 8. Each electrical cable assembly 10 includes an electrical cable termination 18 and an electrical cable 20 coupled to electrical cable termination 18. Header 6 and electrical cable terminations 18 are configured such that each of electrical cable terminations 18 makes electrical contact with at least one of contact pins 14 and printed circuit board ground contact 12 when header 6 and carrier 8 are in a mated configuration.

Electrical cable terminations that can be used in conjunction with carrier 8 can be constructed substantially similar to the shielded controlled impedance (SCI) connectors for a coaxial cable described in U.S. Pat. No. 5,184,965, incorporated by reference herein. Each of the plurality of electrical cable terminations 18 is adapted to receive second ends 14b of a mating contact pin 14. Each electrical cable termination 18 includes a contact beam 22 adjacent its leading edge 18a for making electrical contact with the printed circuit board ground contact 12 on the printed circuit board 4 as carrier 8 engages header 6. In this manner, the electrical path from printed circuit board 4 to electrical cable 20 is made as short as possible, thereby dramatically improving the performance of carrier 8 over what would be otherwise expected with a surface mount header 6.

In the embodiment illustrated in FIGS. 1 and 2, a carrier 8 is provided for each header 6 on printed circuit board 4, with one carrier 8 positioned on either side of the printed circuit board 4. The use of carrier 8 on either side of printed circuit board 4 is preferred to balance the mechanical contacting force between printed circuit board 4 and electrical cable terminations 18, thereby preventing printed circuit board 4 from bending or warping over time.

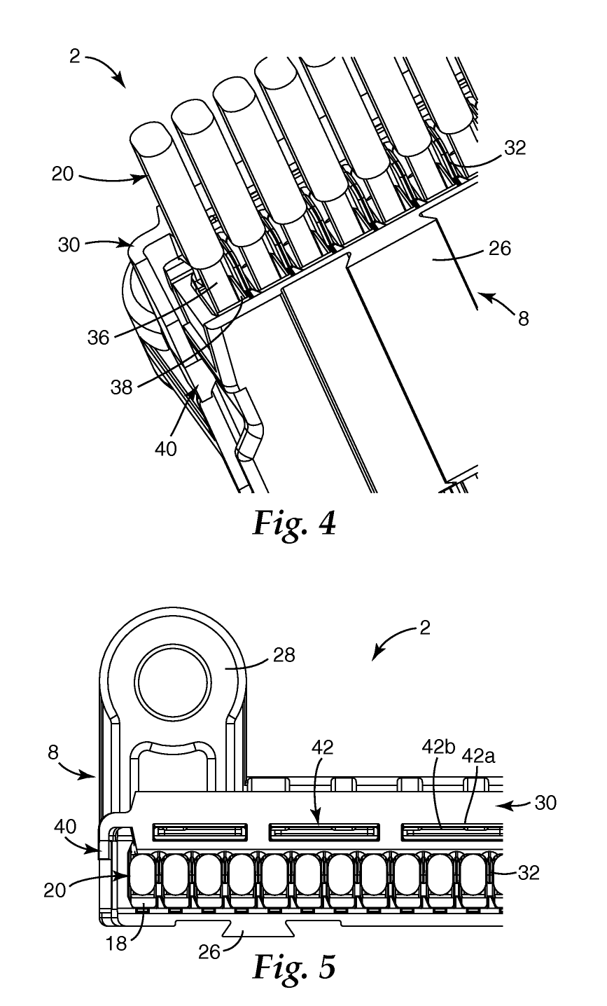

Carriers 8 placed on opposite sides of printed circuit board 4 include guides 24 to properly align carriers 8 with headers 6. Carriers 8 are preferably resiliently secured against each other, such as by a plurality of dove tails 26 (as shown in FIGS. 4 and 5) or other means (not shown) which allows carriers 8 to independently “float” on printed circuit board 4. The ability to float on printed circuit board 4 permits accommodation of variations in printed circuit board thickness which are normal in the industry. Carriers 8 also include mounting tabs or ears 28 for receiving screws (not shown) for securing carriers 8 to the electronic device (not shown) holding printed circuit board 4.

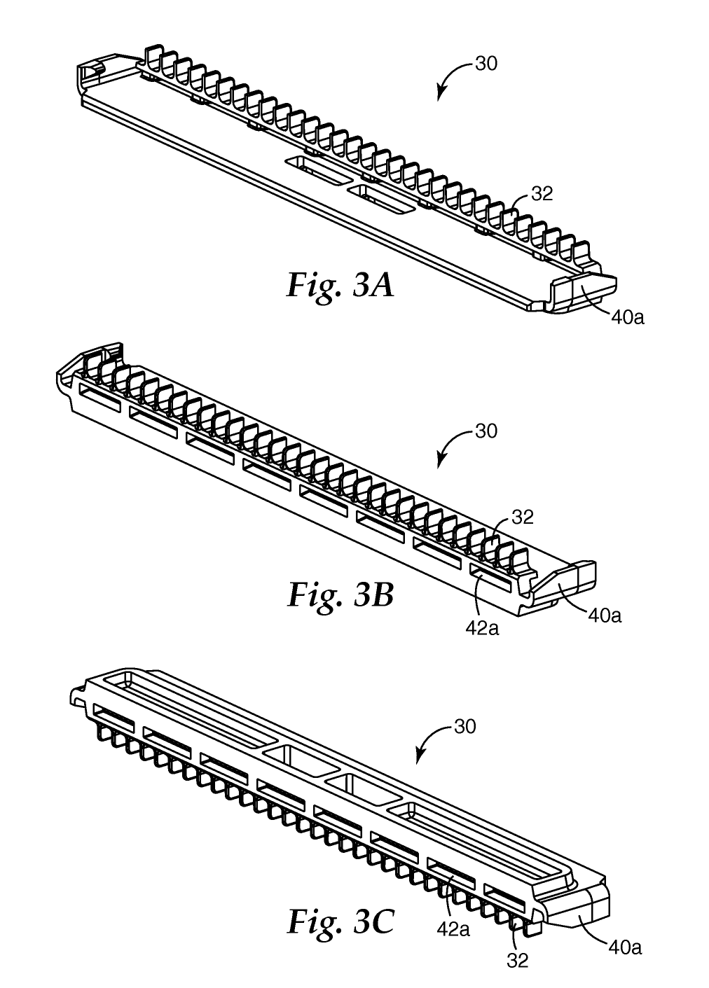

Carrier 8 includes a retention clip 30 (as best illustrated in FIGS. 3A-3C) configured to retain each electrical cable assembly 10 within its respective cavity 38 of carrier 8. After insertion of each electrical cable assembly 10 into its respective cavity 38 of carrier 8, retention clip 30 is assembled onto carrier 8 (e.g., as described below) thereby preventing electrical cable assemblies 10 from being pulled out of carrier 8. Electrical cable assemblies 10 can be removed from carrier 8 individually or as a set by removing retention clip 30 and pulling gently on the one or more associated electrical cables 20. The ability to remove and replace electrical cable assemblies 10 individually or as a set is beneficial when replacing one or more damaged or defective electrical cable terminations 18 or electrical cables 20, for example.

In one embodiment, retention clip 30 and carrier 8 further comprise cooperative latch elements 40 configured to retain retention clip 30 and carrier 8 in an assembled configuration. In the embodiment illustrated in FIGS. 1 and 2, retention clip 30 includes latch arms 40a that deflect to engage latch pockets 40b on carrier 8. It is understood and intended that different and/or additional latch elements 40 may be provided as is suitable for the intended application.

Retention clip 30 has a plurality of separating elements 32 configured to separate at least a portion of electrical cables 20 from each other (as best illustrated in FIG. 4). Electrical cables 20 each include one or more conductors 34 and a ground shield 36 surrounding the one or more conductors 34. In one embodiment, separating elements 32 are configured to separate an exposed portion of ground shield 36 of electrical cables 20 from each other to prevent the exposed portions of ground shields 36 from making electrical contact with each other. In one aspect, this facilitates power distribution through ground shields 36 without the risk of electrical shorting between ground shields 36 of adjacent electrical cables 20. In another embodiment, separating elements 32 are configured to separate an exposed portion of one or more conductors 34 of electrical cables 20 from each other to prevent the exposed portions of one or more conductors 34 from making electrical contact with each other. In one aspect, this facilitates power distribution through one or more conductors 34 without the risk of electrical shorting between one or more conductors 34 of adjacent electrical cables 20. Power distribution may also take place through both ground shield 36 and one or more conductors 34 of one or more electrical cables 20. Running power through a ground shield 36 and/or one or more conductors 34 enables a system designer to more efficiently deliver power to a system, because it may take the place of additional power lines or power connectors, thereby saving connector real estate and cost. In one embodiment, electrical connector assembly 2 has a power distribution capacity of less than about 3 A per line. In one aspect, this means that each electrical cable assembly 10, including electrical cable termination 18 and electrical cable 20, has a power distribution capacity of less than about 3 A. In some applications, such as, e.g., Automatic Test Equipment (ATE) applications, a power distribution capacity of less than about 3 A per line is sufficient to adequately provide power to a system. In one embodiment, one or more conductors 34 are configured to provide signal and ground connections, and ground shield 36 is configured to provide a power connection, which allows a single electrical cable assembly 10 to simultaneously provide signal, ground, and power connections to a system.

Separating elements 32 of retention clip 30 may be configured to organize and/or provide strain relief to electrical cables 20. Separating elements 32 assist in keeping electrical cables 20 parallel to each other near carrier 8. In one aspect, this provides improved visibility of the relative position of each electrical cable 20 and electrical cable termination 18, e.g., to facilitate visual inspection of the assembly. In another aspect, this reduces bending of electrical cables 20 near carrier 8, thereby preserving the integrity of electrical cables 20 near carrier 8 and the connection of each electrical cable 20 to its corresponding electrical cable termination 18.

In one embodiment, retention clip 30 is designed such that it separates the individual electrical cables 20 from each other during its positioning and assembling to carrier 8. The initial separation of electrical cables 20 happens when retention clip 30 is positioned such that each separating element 32 of retention clip 30 is positioned in between at least a portion of two adjacent electrical cables 20. After positioning retention clip 30, it is assembled to carrier 8.

In one embodiment, assembling retention clip 30 to carrier 8 includes sliding retention clip 30 along electrical cables 20, pivoting it, and snapping it onto carrier 8. Sliding retention clip 30 along electrical cables 20 towards carrier 8 continues the separation of electrical cables 20. The positioning and sliding of retention clip 30 is also referred to as the combing of electrical cables 20. Retention clip 30 and separating elements 32 are designed such that the combing of electrical cables 20 can take place with retention clip 30 tilted backward (as illustrated by arrow A in FIG. 1) to further facilitate separation and organization of electrical cables 20. When retention clip 30 approaches carrier 8, cooperative positioning elements 42 (as best illustrated in FIG. 5) properly align and position retention clip 30 relative to carrier 8. In the illustrated embodiment, retention clip 30 includes positioning openings 42a that are configured to receive positioning ribs 42b on carrier 8. It is understood and intended that different and/or additional positioning elements 42 may be provided as is suitable for the intended application. When retention clip 30 then abuts carrier 8 and is properly aligned and positioned, it is pivoted forward (as illustrated by arrow B in FIG. 1) and snapped onto carrier 8 using latch elements 40. After retention clip 30 is snapped onto carrier 8, electrical cable assemblies 10 are retained by carrier 8 and retention clip 30, and each separating element 32 of retention clip 30 is positioned in between at least a portion of two adjacent electrical cables 20, thereby separating at least a portion of electrical cables 20 from each other (e.g., to facilitate power distribution through ground shields 36 of electrical cables 20 without the risk of electrical shorting between ground shields 36 of adjacent electrical cables 20), organizing electrical cables 20, and/or providing strain relief to electrical cables 20.

It is understood and intended that different and/or additional assembly methods may be provided as is suitable for the intended application, including but not limited to snap fitting, friction fitting, press fitting, mechanical clamping, and adhering.

In each of the embodiments and implementations described herein, the various components of the electrical connector assembly and elements thereof are formed of any suitable material. The materials are selected depending upon the intended application and may include both metals and non-metals (e.g., any one or combination of non-conductive materials including but not limited to polymers, glass, and ceramics). In one embodiment, the electrically insulative components, such as, e.g., carrier 8 and retention clip 30, are formed of a polymeric material by methods such as injection molding, extrusion, casting, machining, and the like, while the electrically conductive components, such as, e.g., contact pins 14 and portions of electrical cable terminations 18 are formed of metal by methods such as molding, casting, stamping, machining, and the like. Material selection will depend upon factors including, but not limited to, chemical exposure conditions, environmental exposure conditions including temperature and humidity conditions, flame-retardancy requirements, material strength, and rigidity, to name a few.

Although specific embodiments have been illustrated and described herein for purposes of description of the preferred embodiment, it will be appreciated by those of ordinary skill in the art that a wide variety of alternate and/or equivalent implementations calculated to achieve the same purposes may be substituted for the specific embodiments shown and described without departing from the scope of the present invention. Those with skill in the mechanical, electromechanical, and electrical arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. An electrical connector assembly comprising:
a printed circuit board having a printed circuit board ground contact;
a header coupled to the printed circuit board and comprising a plurality of contact pins;
a carrier configured to mate with the header; and
a plurality of electrical cable assemblies retained by the carrier, each electrical cable assembly comprising an electrical cable termination and an electrical cable coupled to the electrical cable termination,
wherein the header and electrical cable terminations are configured such that each of the electrical cable terminations makes electrical contact with at least one of the contact pins and printed circuit board ground contact when the header and carrier are in a mated configuration, and wherein the carrier includes a retention clip having a plurality of separating elements configured to separate at least a portion of the electrical cables from each other.

2. The electrical connector assembly of claim 1, wherein the printed circuit board ground contact comprises one or more of a plurality of ground pins, an electrically conductive strip, and a plurality of ground pads.

3. The electrical connector assembly of claim 1, wherein the printed circuit board ground contact is positioned adjacent an edge of the printed circuit board.

4. The electrical connector assembly of claim 1, wherein the header is a surface mount pin header.

5. The electrical connector assembly of claim 1, wherein the header is a through-hole pin header.

6. The electrical connector assembly of claim 1, wherein the electrical connector assembly has a power distribution capacity of less than about 3 A per line.

7. An electrical connector comprising:
a carrier; and
a plurality of electrical cable assemblies retained by the carrier, each electrical cable assembly comprising an electrical cable termination and an electrical cable coupled to the electrical cable termination,
wherein the carrier includes a retention clip having a plurality of separating elements configured to separate at least a portion of the electrical cables from each other.

8. The electrical connector of claim 7, wherein the electrical cables comprise one or more conductors and a ground shield surrounding the one or more conductors.

9. The electrical connector of claim 8, wherein the separating elements and one or both of the one or more conductors and the ground shield are configured to facilitate power distribution.

10. The electrical connector of claim 8, wherein the separating elements are configured to separate an exposed portion of one or both of the one or more conductors and the ground shield.

11. The electrical connector of claim 7, wherein the separating elements are configured to organize the electrical cables.

12. The electrical connector of claim 7, wherein the separating elements are configured to provide strain relief to the electrical cables.

13. The electrical connector of claim 7, wherein the electrical connector has a power distribution capacity of less than about 3 A per line.

14. The electrical connector of claim 7, wherein the plurality of electrical cable assemblies are individually removable from the carrier.

15. The electrical connector of claim 7, wherein the plurality of electrical cable assemblies are removable from the carrier as a set.

16. The electrical connector of claim 7, wherein the plurality of electrical cable assemblies are selected from the group consisting of coaxial cable assemblies and twinaxial cable assemblies.

17. The electrical connector of claim 7, wherein the retention clip and carrier further comprise cooperative latch elements configured to retain the retention clip and carrier in an assembled configuration.

18. A method comprising:
providing an electrical connector including a carrier and a plurality of electrical cable assemblies retained by the carrier, each electrical cable assembly comprising an electrical cable termination and an electrical cable coupled to the electrical cable termination;
positioning a retention clip having a plurality of separating elements such that each separating element is positioned in between at least a portion of two adjacent electrical cables; and
assembling the retention clip to the electrical connector.

19. The method of claim 18, wherein assembling the retention clip to the electrical connector comprises:
sliding the retention clip along the electrical cables toward the electrical connector;
pivoting the retention clip; and
snapping the retention clip onto the electrical connector.

20. The method of claim 18, wherein assembling comprises one of snap fitting, friction fitting, press fitting, mechanical clamping, and adhering.
